(19) United States
(12) Patent Application Publication
(10) Pub. No.: US 2012/0059886 A1
(43) Pub. Date: Mar. 8, 2012

(54) REPLY MESSAGE HANDLING FOR TRANSIENT GROUP

(76) Inventor: Gary Stephen Shuster, Fresno, CA (US)

(21) Appl. No.: 13/221,763

(22) Filed: Aug. 30, 2011

Related U.S. Application Data
(60) Provisional application No. 61/378,119, filed on Aug. 30, 2010.

(51) Int. Cl. G06F 15/16

(52) U.S. Cl. 709/206

(57) ABSTRACT

An electronic mail client inserts an identifier into incoming messages based on determining that the incoming message is addressed to more than one addressee (e.g., the message is addressed to an addressee group). The client stores the identifiers and the addresses for the addressee group in a database. The client or other node for outgoing electronic mail analyzes outgoing messages containing the identifier to determine whether or not the outgoing message is addressed to all addresses in the addressee group, and takes an action based on the determination.

### CROSS-REFERENCE TO RELATED APPLICATION

This application claims priority pursuant to 35 U.S.C. §119(e) to U.S. provisional application Ser. No. 61/378,119, filed Aug. 30, 2010, which is hereby incorporated by reference in its entirety.

### BACKGROUND

1. Field

The present disclosure relates to electronic mail, and more particularly to addressing of outgoing electronic mail.

2. Description of Related Art

Electronic mail may typically be controlled according to a standard protocol, for example, Simple Mail Transfer Protocol (SMTP). Email users of SMTP and similar protocols may often wish to conduct a multiparty conversation on a topic, but do so with other users who do not understand that they must “reply all” in order to continue the conversation with the totality of other participants, or simply forget to select “reply all” instead or “reply” when configuring sending of an outgoing message. A mail client may, in response to receiving a “reply all” command associated with an outgoing message, include all addresses listed in the “sender,” “from,” “cc:” or similarly designated data fields listing all addresses receiving the original message in one or more recipient address fields of the outgoing message. Subsequently, an outgoing mail server may direct the message to the listed recipient addresses. In comparison, if the mail client or outgoing mail server receives a simple “reply” command associated with an outgoing message, the mail client mail include only the address of the actual listed message sender in the recipient address fields for the message, which will therefore remain devoid of other addresses unless manually placed there by the sender. Subsequently, the outgoing mail server may direct the message to the sole listed recipient only.

This aspect of the prior art may be intended as a feature to permit individual replies, but in practice may have the result of unintentionally leaving out person who should be expected to receive the reply message. To avoid this, other messaging option may be available, such as mailing lists, group service and group bulletin boards. However, for relatively transitory communication threads, the use of mailing lists or services such as “Google® groups” is impractical. Furthermore, mailing lists and group memberships are persistent, which may be undesirable in some circumstances, and way result in unsolicited commercial email or other undesired email coming through the group membership.

### SUMMARY

Novel methods, system, and apparatus are disclosed herein to manage addressing of outgoing mail to ensure intended recipients are included in the addressee list. In an aspect, a method may be performed using a mail client, outgoing electronic mail server or some combination of these or similarly configured computer entities handling electronic mail, generally referred to herein as a “mail client.” In an aspect, the method may include receiving an incoming electronic message from an original source designating multiple recipient addresses. In response to receiving the incoming electronic message, the mail client may insert an identification token in the incoming electronic message. The mail client may obtain the identification token using a random, pseudo-random, systematic, or other character string generator to generate or otherwise obtain the token as a unique character string identifier for the particular group of multiple recipient addresses identified in the incoming electronic mail message. The identification may be inserted anywhere in the electronic message, including but not limited to a message header or reply-to field of the message. In another aspect, the method may include associating the identification token to a list identifying the multiple recipient addresses, using an electronic data structure.

Once inserted into the incoming message, the identification token may therefore also be inserted or present in a normal reply to the incoming message. This is because the incoming message, as part of default to normal message handling, may be appended to or included with a reply. Accordingly, the message may further include reading the identification token in an outgoing electronic message. Then, the method may include identifying one or more omitted recipient addresses for the outgoing electronic message, using the identification token to determine that each of the one or more omitted recipient addresses is identified in the list identifying the multiple recipient addresses and is not included in any recipient address field of the outgoing message. In short, the outgoing mail client may determine whether any address included in the incoming message is missing. In response to identifying the one or more omitted recipient addresses, the method may include providing a sender of the outgoing electronic message with an option for adding the one or more omitted recipient addresses to an addressee field of the outgoing electronic message. With or without first providing the user with an option, the method may include placing the one or more omitted recipient addresses in an addressee field of the outgoing electronic message. Subsequently, the method may include transmitting the outgoing electronic message to all addressees indicated therein, including to the one or more omitted recipient addresses.

In a further aspect, the one or more omitted recipient addresses may be located in a “blind copy” (bcc) field of the incoming electronic message. In another aspect, the method may include inserting a notification message in the incoming electronic message, indicating that replies to the incoming electronic message will be transmitted to all of the multiple recipient addresses.

In another aspect, the method may include transmitting the outgoing electronic message to all addressees indicated therein including to the one or more omitted recipient addresses, based on first determining that a group reply function for the incoming electronic message is not deactivated. The method may further include deactivating the group reply function in response to a predetermined event. Said predetermined event may be selected from the group consisting of (i) receiving a deactivation signal from one of a sender of the incoming electronic message or recipients indicated by the multiple recipient addresses, or (ii) expiration of a designated time period after original transmission of the incoming electronic message.

The identification token may be inserted in various places in the incoming message. In an aspect, the method may include inserting the identification token in a sender address field of the incoming electronic message. For example, the method may include replacing all contents of the sender address field with the identification token.

In another aspect, the method may include generating the identification token as a distinctive character string included in an electronic address. With respect to this aspect, the method may further include selecting the electronic address for an electronic component processing outgoing electronic messages to identify the one or more omitted recipient addresses. The message may therefore be first sent to the electronic component, which may perform the job of determining if any recipient address is missing from the reply, and related operations.

In related aspects, a computing apparatus (e.g., personal computer or smart phone) may be provided for performing any of the methods and related aspects of the methods summarized above. An apparatus may include, for example, a processor coupled to a memory, wherein the memory holds instructions for execution by the processor to cause the apparatus to perform operations as described above. Similarly, an article of manufacture may be provided, including a non-transient computer-readable storage medium holding encoded instructions, which when executed by a processor, cause a computing apparatus to perform the methods and implement aspects of the methods as summarized above.

A more complete understanding of the method and apparatus for addressing outgoing electronic mail, and other aspects, will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a block diagram illustrating an example of a system and apparatus for addressing electronic mail using one or more novel methods disclosed herein.

FIG. 2 is a block diagram illustrating an example of a method for addressing electronic mail.

FIG. 3 is a block diagram illustrating an example of mail client performing a method for addressing electronic mail.

### DETAILED DESCRIPTION

The present disclosure describes a solution for handling e-mail reply messages to a temporary group of addressees. When sending to multiple recipients, a “reply-to” address of an incoming message may be modified with a code (for example, by the mail client or outgoing mail server) so that when a reply is sent, the message is delivered to the other original recipients.

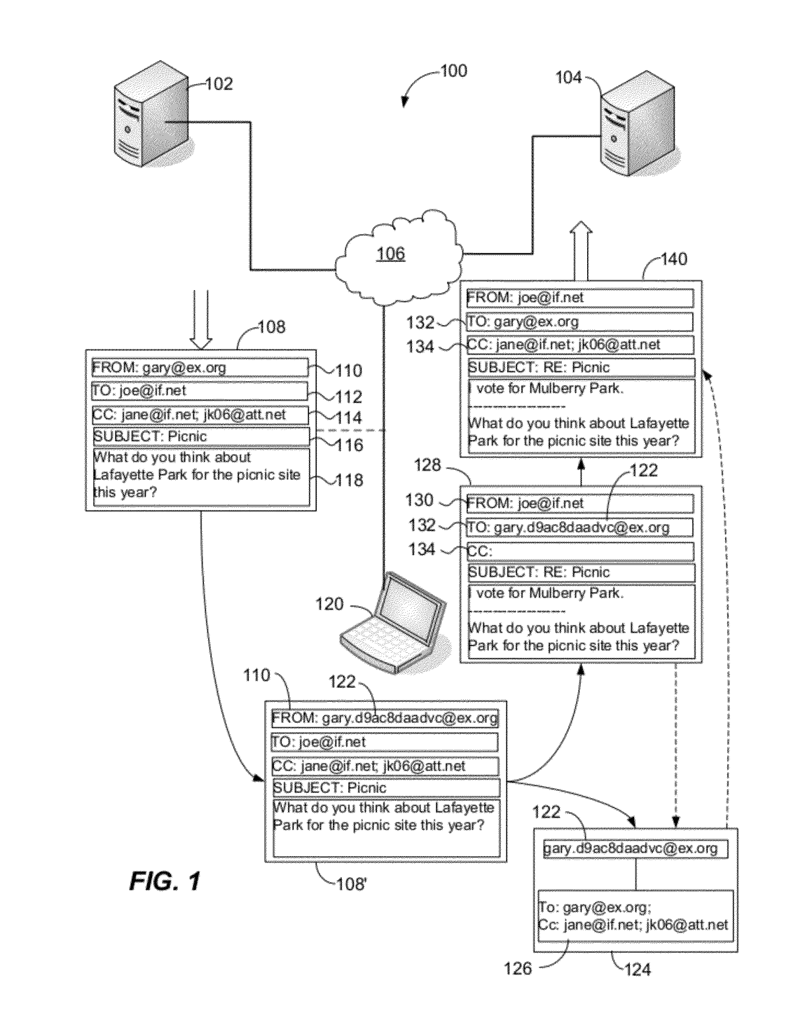

Further details and aspects of a system 100 for handling e-mail reply messages are illustrated in FIG. 1. The system 100 may include an incoming mail server 102 and an outgoing mail server 104 coupled to an electronic mail client 120 via a wide area network (WAN) 106, local area network (LAN), or other computer network or combinations of networks, including wireless networks. The incoming mail server 102 and outgoing mail server 104 may be integrated into a single machine, or may comprise two or more separate machines. The incoming mail server 102 may perform functions such as receiving incoming email for a domain, storing incoming messages at least until delivered to a mail client 120, and transmitting incoming messages to the mail client. The outgoing mail server 104 may perform functions such as receiving outgoing messages from one or more mail clients, storing the outgoing messages at least until delivered, and transmitting outgoing messages to their addresses recipients. The servers 102 and 102 may also perform one or more functions described herein as being performed by the mail client 120, pertaining to handling of incoming and outgoing mail, respectively. For simplicity of illustration, the examples herein describe these actions as performed by a mail client 120, although the disclosure is not limited thereby.

The incoming mail server 102 may transmit incoming messages to the mail client 120. So, for example, an email 108 may include, according to SMTP or other mail protocol, a “sender” data field 110 indicating that the message 108 is from gary@ex.org, a “recipient” data field 112 indicating that the message should be delivered to joe@iff.net, a “cc” or “carbon copy” data field 114 indicating that copies were sent to jane@if.net and jk06@att.net. An outgoing message may include a “bcc” or “blind carbon copy” data field (not shown); such a field may not be included messages transmitted to other recipients. The addresses gary@ex.org, joe@iff.net, jane@if.net and jk06@att.net are merely illustrative examples of SMTP mail addresses, and are not intended to illustrate actual mail addresses or to limit the scope of the disclosure. The incoming message 108 may further include a subject field 116 for holding text describing a message subject, a message body field 118 for holding the message body, and any number of other fields permitted by the applicable mail protocol.

The mail client 120 may automatically assign a special reply-to address, also called an identification token 122, for example“gary.d9ac8daadvc@ex.com.” The identification token 122 may include a unique character string, in the present example “d9ac8daadvc,” which is suitable for serving as a distinct identifier token that may be readily and reliably detected by parsing an email message. The special identifier may be placed in any email field capable of holding it without disrupting normal use of the email, for example in the sender field 108 where it may replace the original sender address, to prepare an altered email message 108′.

The token 122 may be comprised in part, optionally in an encrypted manner, of the recipient list. When so constructed, no additional data source would be required to identify the recipients. Optionally, there may be a validation segment of the token that can be checked against a database or formulaic validation means to determine if the token was legitimately generated. Use of the token may also be limited to set originating IP addresses, domain names, service providers, users, email matching a set requirement of a “sender” field, or the original sender and/or members of the original recipient list. In one variation, the token may utilize a compression system to minimize the token size. In one compression system, a single data portion, such as a byte, may be used to represent a domain name that also appears in conjunction with another recipient encoded into the token.

The mail handling application/mail client 120 may also make a database entry or other data record 124 indicating that the automatically assigned identifier 122 is associated with or indicates a list 126 that includes all of the recipient addresses, including, for example, gary@ex.org, jane@if.net and jk06@att.net. The outgoing mail application may similarly create the list 126, if it does not already exist. The list 126 or a related record may indicate the status of each recipient address, for example, a primary recipient or carbon copy recipient.

Subsequently, a recipient of the email message may generate a reply message 128, for example by selecting a “reply” command using a mail browsing application. The mail browsing application may operate independently of the mail handling application. If the sender of the reply 128 has selected “reply to sender only” or equivalent command in the mail browser application, this may cause the reply message 128 to be directed to the special address/identification token 122 indicated in the recipient data field 130. For example, the reply message 128 may be addressed to gary.d9ac8daadvc@ex.com only. The carbon copy field 134 may be empty, and the sender field 130 may indicate the address of the reply sender. The reply message may also include other message fields as previously described.

The mail address/token 122 may indicate an address for a mail server, or may not operate as a mail address. When the reply email 128 is received at the SMTP server, POP3 server, within an end user email program at the client 120, or other operative mail node, the email 128 may be analyzed to determine whether it includes any identifier token 122 matching a database entry for email distribution lists. In response to detecting a token 122 associated with a particular list 126, the email 128 may be examined to determine whether any of the recipients in the list 126 have been omitted from designated recipients of the message 128 appearing in fields 132 or 134. In addition, the message 128 may be analyzed to determine whether the original sender matches the correct original source for the relevant distribution list. The operative mail node (e.g., mail client 120) may then insert any missing addressees into the reply 128 to prepare an altered reply message 140. The altered reply may include all of the addresses for the designated recipients in the list 126, located in an appropriate one of the addressee fields 132 or 134. The mail client 120 or other mail node may then transmit the altered reply message 140 to all addressees, including to any recipients that may have been omitted from the message 128.

In some embodiments, the originator (or another recipient) of the email may deactivate the database entry, causing the “reply-all” functionality to cease. In other embodiments, the operative mail node may automatically deactivate the reply-all functionality in response to no response being received within a set time frame, in response to expiration of a set time limit, or in response to some other event or condition. In other embodiments, the operative mail node may identify a “reply-all” token in response to detecting that any recipient has replied to the message, and may prompt the recipient who generates the reply message as to whether they want to reply to the sender only, or to all original recipients. For example, the mail node may transmit a reminder reading “the sender has requested that any responses be sent to all original recipients—do you really want to just send to the sender only?”, and providing an option to transmit to the omitted original recipient only. In another embodiment, the email contains a warning indicating to the recipients that hitting “reply” will reply to the entire list of original recipients.

In another embodiment, where at least one recipient, or a set number of recipients, in a “cc” field are included in an outbound message, it may be assumed that the sender intended to omit the other recipients and, optionally after verifying that intent with the sender, the system may omit the additional recipients. In another embodiment, a separate “bcc” token may be utilized to identify a list of one or more “bcc” recipients from an original message, so that any replies are automatically retransmitted to the “bcc” list, allowing the original “bcc” recipients to view the conversation. Such a token may need to be added to the message before it is transmitted to the mail client 120, so that the client 120 does not receive the “bcc” recipients. In another embodiment, a single token may be used for both the bcc and cc functions. In another embodiment, the token may be placed in the subject line 116, body 118, or headers of the email, rather than as part of the “reply-to” field.

In another embodiment, “bcc” recipients may be included in the “cc” field one or more email addresses that utilize a token or point to a mail server capable of reading a token from mail content. Such an embodiment permits “bcc” recipients of the original email to be copied on the subsequent elements of the conversation without having their identities exposed. Optionally the “bcc” recipients may be blocked from utilizing the token system for responses (preserving their “listen but don't write” status), may be permitted to participate by the originator of the message, or may be permitted to participate generally. Where they participate, their identities may optionally continue to be hidden by using a “send from” email address that does not identify them. In another variation, there may be an indication as to the presence or number of “bcc” recipients within the system, and senders of messages may further be permitted to omit or include “bcc” recipients on their responses.

In another embodiment, the recipient email addresses may be altered so that all reply messages transit through the sender's server. The alteration may be performed on the client software or server side, so as to avoid forcing the sender to type complex addresses manually. For example, an email from gary@example.com to president@whitehouse.gov and joe@example.com may automatically altered so that it is addressed to president.[token].whitehouse.gov@example.com and joe.[token]@example.com, and retransmitted from example.com to whitehouse.gov. In this way, replies sent with one of the original recipients as a “bcc” may be apparent to the server and the outgoing mail server may avoid sending the original recipient multiple copies of the email.

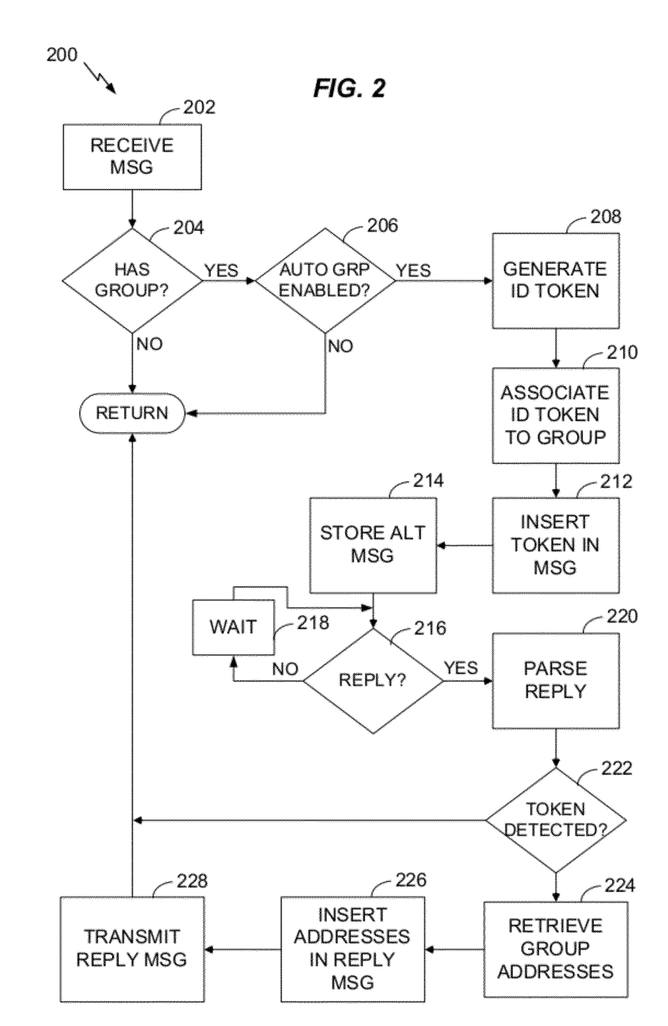

A method 200 may be performed using a mail client as shown in FIG. 2. In an aspect, the method may include receiving 202 an incoming electronic message from an original source designating multiple recipient addresses. In response to receiving the incoming electronic message, the mail client may determine 204 whether the incoming message includes a group of two or more addressees in any one or combination of the recipient, carbon copy, or blind carbon copy fields. If such a group exists, the mail client may further determine 206 whether the automatic reply-all functionality as described herein is enabled for the particular message. For example, enablement or disablement of the automatic reply-all functionality may be indicated as a state variable at the mail client, or may be indicated using one or more designated bits of the incoming message. If the incoming message does not contain any group of two or more addressees, or if automatic reply-all functionality is not enabled, the procedure 200 may terminate.

Otherwise, the mail client may generate 208 the identification token using a random, pseudo-random, systematic, or other character string generator to generate or otherwise obtain the token as a unique character string identifier for the particular group of multiple recipient addresses identified in the incoming electronic mail message. insert an identification token in the incoming electronic message. In another aspect, the method 200 may include associating 210 the identification token to a list identifying the multiple recipient addresses, using an electronic data structure such as a database or the like. In addition, the method may include the mail client inserting 212 the identification token anywhere in the electronic message, including but not limited to a message header or reply-to field of the message, to prepare an altered message. The method 200 may further include, at 214, the mail client storing the altered electronic message in an electronic message. From which it may be accessed using a conventional mail browsing application.

Once inserted into the incoming message, the identification token may therefore also be inserted or present in a normal reply to the incoming message. This is because the incoming message, as part of default to normal message handling, may be appended to or included with a reply. The mail client may therefore, at 216, determine when a reply to the altered message has been prepared for sending, for example, by parsing 220 every outgoing message and determining 222 whether or not the identification token is present in the outgoing message. If no outgoing message exists, the method 200 may include the mail client waiting 218 to receive an outgoing message.

Accordingly, the message may further include reading the identification token in an outgoing electronic message, in relation to detecting the token at 222. If no token exists, the procedure 200 may terminate as to each respective particular outgoing message that does not contain a detected token. Then, the method may include identifying or retrieving 224 one or more omitted recipient addresses for the outgoing electronic message, using the identification token to determine that each of the one or more omitted recipient addresses is identified in the list identifying the multiple recipient addresses and is not included in any recipient address field of the outgoing message. In short, the outgoing mail client may determine whether any address included in the incoming message is missing. In response to identifying the one or more omitted recipient addresses, the method may include providing a sender of the outgoing electronic message with an option for adding the one or more omitted recipient addresses to an addressee field of the outgoing electronic message. With or without first providing the user with an option, the method may include placing or inserting 226 the one or more omitted recipient addresses in an addressee field of the outgoing electronic message. Subsequently, the method may include transmitting 228 the outgoing electronic message to all addressees indicated therein, including to the one or more omitted recipient addresses.

In a further aspect, the one or more omitted recipient addresses may be located in a “blind copy” (bcc) field of the incoming electronic message. In another aspect, the method 200 may include inserting a notification message in the incoming electronic message, indicating that replies to the incoming electronic message will be transmitted to all of the multiple recipient addresses.

In another aspect, the method 200 may include transmitting the outgoing electronic message to all addressees indicated therein including to the one or more omitted recipient addresses, based on first determining at 206 that a group reply function for the incoming electronic message is not deactivated. The method may further include deactivating the group reply function in response to a predetermined event. Said predetermined event may be selected from the group consisting of (i) receiving a deactivation signal from one of a sender of the incoming electronic message or recipients indicated by the multiple recipient addresses, or (ii) expiration of a designated time period after original transmission of the incoming electronic message.

The identification token may be inserted 226 in various places in the incoming message. In an aspect, the method may include inserting the identification token in a sender address field of the incoming electronic message. For example, the method may include replacing all contents of the sender address field with the identification token.

In another aspect, the method may include generating 208 the identification token as a distinctive character string included in an electronic address. With respect to this aspect, the method may further include selecting the electronic address for an electronic component processing outgoing electronic messages to identify the one or more omitted recipient addresses. The message may therefore be first sent to the electronic component, which may perform the job of determining if any recipient address is missing from the reply, and related operations.

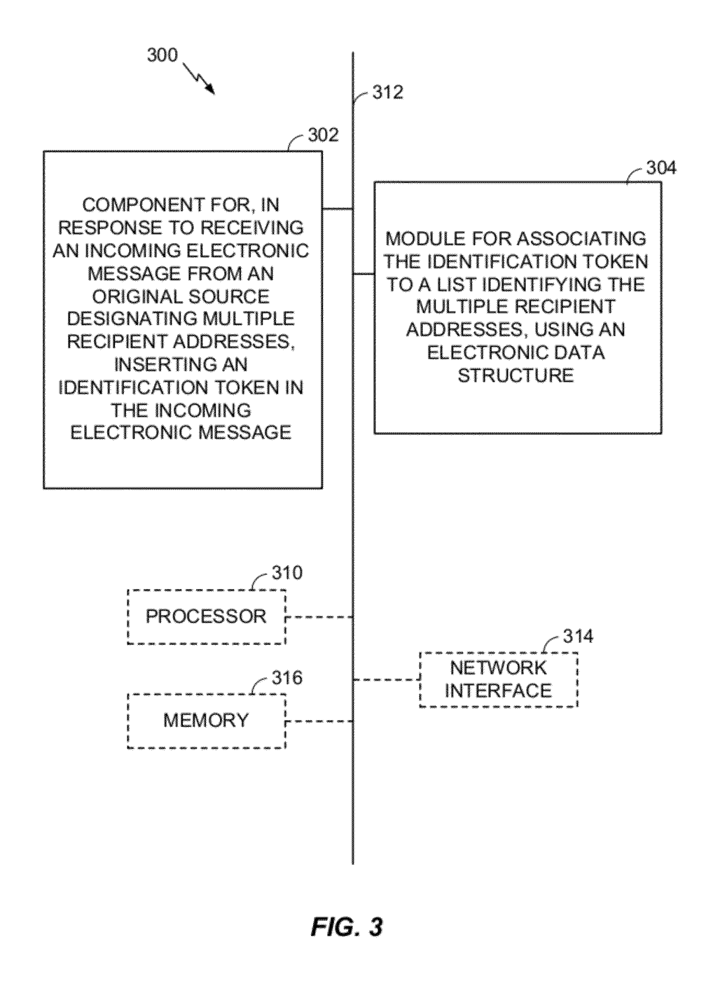

With reference to FIG. 3, there is provided an exemplary apparatus 300 that may be configured as a mail client or other mail handling entity, or as a processor or similar device for use within the mail client or other mail handling entity, for implementing a method for addressing outgoing mail, and related methods. The apparatus 300 may include functional blocks that can represent functions implemented by a processor, software, or combination thereof (e.g., firmware).

In one embodiment, the apparatus 300 may include an electrical component or module 302 for, in response to receiving an electronic message from an original source designating multiple recipient addresses, inserting an identification token into the incoming electronic message. For example, the electrical component 302 may include at least one control processor coupled to a network interface or the like and to a memory with instructions for performing operations as detailed above with respect to FIG. 2, related to generating and inserting an identification token into an incoming message, to identify a specific group of addressees. The apparatus 300 may include an electrical component 304 for associating the identification token to a list identifying the multiple recipient addresses, using an electronic data structure. For example, the electrical component 304 may include at least one control processor coupled to a memory holding instructions for associating the identification token to the list using a data table or database. The apparatus 300 may include similar electrical components for performing any or all of the additional operations or aspects described in connection with FIGS. 1-2 or elsewhere herein, which for illustrative simplicity are not shown in FIG. 3.

In related aspects, the apparatus 300 may optionally include a processor component 310 having at least one processor, in the case of the apparatus 300 configured as an electronic mail client or mail handling node. The processor 310, in such case, may be in operative communication with the components 302-304 or similar components via a bus 312 or similar communication coupling, or may implement the components internally by executing of instructions loaded into its working memory. The processor 310 may effect initiation and scheduling of the processes or functions performed by electrical components 302-304. The processor 310 may encompass the components 302-304, in whole or in part. In the alternative, the processor 310 may be separate from the components 302-304, which may include one or more separate processors.

In further related aspects, the apparatus 300 may include a network interface component 314, for example a Transmission Control Protocol/Internet Protocol (TCP/IP) interface used for receiving and sending electronic mail, and other data or instructions. The apparatus 300 may optionally include a component for storing information, such as, for example, a memory device/component 316. The computer readable medium or the memory component 316 may be operatively coupled to the other components of the apparatus 300 via the bus 312 or the like. The memory component 316 may be adapted to store computer readable instructions and data for performing the activity of the components 302-304, and subcomponents thereof, or the processor 310, or the additional aspects of the methods disclosed herein. The memory component 316 may retain instructions for executing functions associated with the components 302-304. While shown as being external to the memory 316, it is to be understood that the components 302-304 can exist within the memory 316. The memory, or other memory, may also be used to store data used by the components.

Those of skill would further appreciate that the various illustrative logical blocks, components, and algorithm steps described in connection with the disclosure herein may be implemented as electronic hardware, computer software, or combinations of both. In accordance with the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other configuration.

Similarly, steps of a method or algorithm or functions described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, an optical disc medium, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. If implemented in software, the steps or functions may be stored on or transmitted over as one or more instructions or code on a computer-readable medium. Computer-readable media includes both computer storage media and non-transitory communication media including any non-transitory tangible medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disc storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method, comprising:
in response to receiving an incoming electronic message from an original source designating multiple recipient addresses, inserting an identification token in the incoming electronic message; and
associating the identification token to a list identifying the multiple recipient addresses, using an electronic data structure.

2. The method of claim 1, further comprising reading the identification token in an outgoing electronic message.

3. The method of claim 2, further comprising identifying one or more omitted recipient addresses for the outgoing electronic message, using the identification token to determine that each of the one or more omitted recipient addresses is identified in the list identifying the multiple recipient addresses and is not included in any recipient address field of the outgoing message.

4. The method of claim 3, further comprising, in response to identifying the one or more omitted recipient addresses, providing a sender of the outgoing electronic message with an option for adding the one or more omitted recipient addresses to an addressee field of the outgoing electronic message.

5. The method of claim 3, further comprising placing the one or more omitted recipient addresses in an addressee field of the outgoing electronic message.

6. The method of claim 5, further comprising transmitting the outgoing electronic message to all addressees indicated therein, including to the one or more omitted recipient addresses.

7. The method of claim 3, wherein the one or more omitted recipient addresses is located in a “blind copy” (bcc) field of the incoming electronic message.

8. The method of claim 3, further comprising inserting a notification message in the incoming electronic message, indicating that replies to the incoming electronic message will be transmitted to all of the multiple recipient addresses.

9. The method of claim 3, further comprising transmitting the outgoing electronic message to all addressees indicated therein including to the one or more omitted recipient addresses, based on first determining that a group reply function for the incoming electronic message is not deactivated.

10. The method of claim 9, further comprising deactivating the group reply function in response to a predetermined event.

11. The method of claim 10, wherein the predetermined event is selected from the group consisting of (i) receiving a deactivation signal from one of a sender of the incoming electronic message or recipients indicated by the multiple recipient addresses, or (ii) expiration of a designated time period after original transmission of the incoming electronic message.

12. The method of claim 1, further comprising inserting the identification token in a sender address field of the incoming electronic message.

13. The method of claim 12, further comprising replacing all contents of the sender address field with the identification token.

14. The method of claim 12, further comprising generating the identification token as a distinctive character string included in an electronic address.

15. The method of claim 14, further comprising selecting the electronic address for an electronic component processing outgoing electronic messages to identify the one or more omitted recipient addresses.

16. A apparatus, comprising a processor coupled to a memory, wherein the memory hold program instructions, that when executed by the processor, cause the apparatus to:
in response to receiving an incoming electronic message from an original source designating multiple recipient addresses, insert an identification token in the incoming electronic message; and
associate the identification token to a list identifying the multiple recipient addresses, using an electronic data structure.

17. The apparatus of claim 16, wherein the memory holds further instructions for reading the identification token in an outgoing electronic message.

18. The apparatus of claim 17, wherein the memory holds further instructions for identifying one or more omitted recipient addresses for the outgoing electronic message, using the identification token.

19. The apparatus of claim 18, wherein the memory holds further instructions for, in response to identifying the one or more omitted recipient addresses, placing the one or more omitted recipient addresses in an addressee field of the outgoing electronic message.

20. The apparatus of claim 16, wherein the memory holds further instructions for generating the identification token as a distinctive character string included in an electronic message address.
